(19) United States
(12) Patent Application Publication
(10) Pub. No.: US 2010/0024660 A1
(43) Pub. Date: Feb. 4, 2010

(54) SELF-SEALING COCKTAIL CARBONATION APPARATUS

(75) Inventor: R. Evan Wallace, Seattle, WA (US)

Correspondence Address: DARBY & DARBY P.C., P.O. BOX 770, Church Street Station, New York, NY, 10008-0770, US

(73) Assignee: Perlage Systems, Inc., Seattle, WA (US)

(21) Appl. No.: 12/511,876

(22) Filed: Jul. 29, 2009

Related U.S. Application Data
(60) Provisional application No. 61/085,395, filed on Jul. 31, 2008.

(51) Int. Cl. A23L 2/54; B01F 3/04

(52) U.S. Cl. 99/323.2

(57) ABSTRACT

An apparatus and method are disclosed for carbonation of liquids, such as beverages like cocktails. The apparatus includes a transparent container having a small opening and a twist-lock large opening. The small opening includes a self-sealing one-way valve to introduce a gas, such as CO2, into the container. The large opening is used to load the liquid and solid ingredients, such as ice and fruit chunks. The large opening includes an O-ring to self-seal the container upon pressurization by the gas. A light port at the bottom of the container may be provided through which a light may be shone for visual effects. In operation, the user fills the container through the large opening with ice and fruit chunks, and twists the large opening shut. The user then injects CO2 through the valve and shakes the container to produce high-quality highly carbonated cocktails that sparkle much like Champagne.

### ELATED APPLICATIONS

This application claims the benefit of U.S. Provisional Patent Application No. 61/085,395, filed Jul. 31, 2008, the entire contents of which is incorporated by reference.

### TECHNICAL FIELD

The present disclosures relate to a method and apparatus for creating carbonated beverages. In particular, the present disclosures are directed to an apparatus used for introducing carbonation while making beverages shaken over ice and other ingredients to create sparkling cocktails.

### BACKGROUND

There have been a number of devices aimed at the home market over the years intended for the carbonation of water and other liquids and beverages. These devices typically have narrow openings through which the liquid ingredients are added. This feature, among other characteristics, renders these devices of limited value for commercial use in restaurants and bars because the narrow opening limits the addition of other ingredients, such as fruit and ice chunks, to the beverage.

The ability to add ice is important to the process of making beverages, such as cocktails, as ice is typically used in a shaken cocktail both to cool and dilute the resulting drink. In the present disclosures, the shaking action also quickly dissolves pressurized carbon dioxide stored in a headspace of the container into the drink, simultaneously cooling, diluting, and carbonating all of the liquid ingredients. Cooling the drink is important not just for taste. Carbon dioxide absorption in liquids is strongly dependent on temperature. The colder the liquid, the more carbon dioxide can dissolve into solution, making the drink more highly carbonated and increasing the duration of carbonation bubbles. Without the ability to easily add ice, all of the ingredients would have to be pre-chilled to achieve acceptable carbonation levels, which would be impractical and inconvenient in most circumstances.

The shaking action also has multiple purposes. Not only does shaking dilute the cocktail and cool the drink, it also agitates the liquid and vastly increases the surface area through which carbon dioxide can dissolve into the liquid. This decreases the amount of time required to adequately carbonate the beverage from hours to seconds.

### BRIEF DESCRIPTION OF THE DRAWINGS

Non-limiting and non-exhaustive embodiments of the present disclosure are described with reference to the following drawings. In the drawings, like reference numerals refer to like parts throughout the various figures unless otherwise specified.

For a better understanding of the present disclosure, the following Detailed Description is intended to be read in association with the accompanying drawings, wherein:

FIG. 1 is pictorial diagram of an illustrative embodiment of a cocktail shaker and a gas delivery device;

FIG. 2 is an exploded pictorial diagram of the illustrative embodiment of the cocktail shaker of FIG. 1;

FIG. 3 is a pictorial diagram showing a detailed sectional view of the illustrative embodiment of the cocktail shaker of FIG. 1;

FIG. 4A, 4B are pictorial diagrams of a small inlet detail of the illustrative embodiment of the cocktail shaker of FIG. 1;

FIG. 5 is a pictorial diagram of an O-ring seal detail of the illustrative embodiment of the cocktail shaker of FIG. 1;

FIG. 6 is pictorial diagram of a large inlet detail of the illustrative embodiment of the cocktail shaker of FIG. 1; and

FIG. 7 is a flow diagram of an illustrative method of carbonating liquids.

### DETAILED DESCRIPTION

The following description is presented to enable a person skilled in the art to make and use the disclosure, and is provided in the context of particular applications of the disclosure and their requirements. Various modifications to the disclosed embodiments will be readily apparent to those skilled in the art and the general principles defined herein may be applied to other embodiments and applications without departing from the spirit and scope of the present disclosure. Thus, the present disclosure is not intended to be limited to the embodiments shown, but is to be accorded the widest scope consistent with the principles and features disclosed herein.

Throughout the specification, and in the claims, the term “connected” means a direct physical connection between the components that are connected, without any intermediate components. The term “coupled” means either a direct physical connection between the components that are connected, or an indirect connection through one or more intermediary components.

Briefly described, aspects of the present disclosure are related to an apparatus and method for carbonation of liquids, such as beverages like cocktails. In one illustrative embodiment, the apparatus includes a container with two openings, one small and one large. The small opening includes a self-sealing one-way valve to introduce a gas, such as carbon dioxide (CO2), into the container. The large opening is used to load the liquid and solid ingredients. The large opening includes an O-ring type seal, made of a flexible material, such as rubber, to self-seal the container upon pressurization by the gas. The large opening has a twist-lock or other quick locking configuration for fast opening and closing of the large opening. The container is made from a transparent material to enable a user to see the process of carbonation of the beverage. A light port at the bottom of the container may be provided through which a light may be shone for visual effects. In operation, the user closes the small opening, twists open the large opening and loads the container with liquid, solid ingredients, and ice, and twists the large opening shut. The user then introduces the gas through the small opening and vigorously shakes the container to mix all the ingredients while dissolving the gas in the liquid. The apparatus described herein may be used for producing drinks that are typically shaken over ice and other ingredients, such as chunks of fruits, like those produced in commercial and home bars using a cocktail shaker (for example, Cosmopolitans and Martinis). The apparatus described may be used to produce high-quality highly carbonated cocktails that sparkle much like Champagne.

Although through-out this specification, the descriptions and drawings are directed to a manual cocktail shaker, but the disclosure is not so limited. The same basic system configuration and methods may be used at larger scales, such as a drum container, in which carbonated cocktails may be produced in bulk in a stationary apparatus, without departing from the spirit of the disclosures. Additionally, the same basic apparatus and method may also be used in automated or machine-operated cocktail shakers. And although the descriptions are presented with respect to the preparation of a cocktail beverage using CO2 gas, the same apparatus and process may be used to dissolve other types of gas in other non-beverage liquids for other purposes.

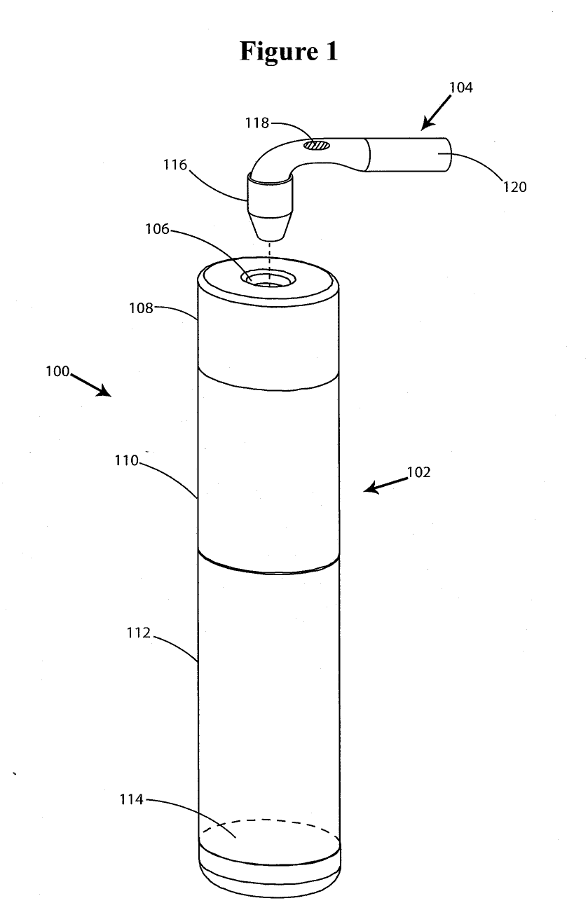

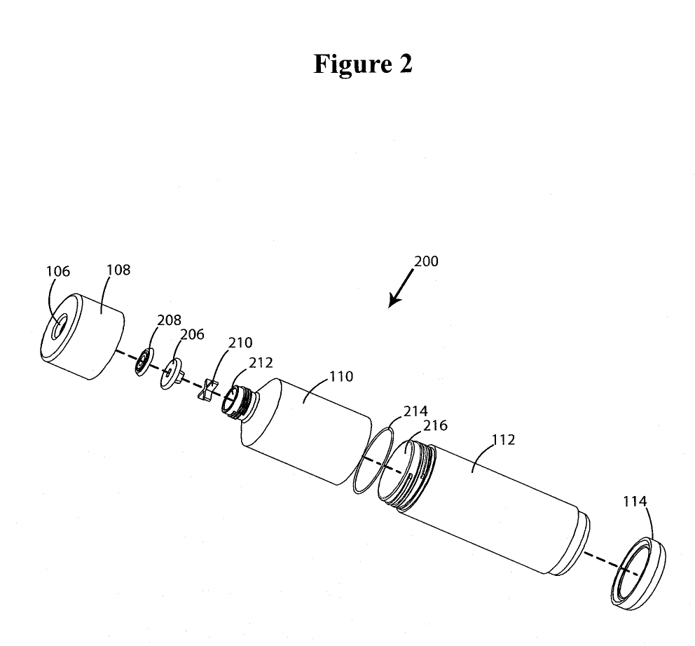

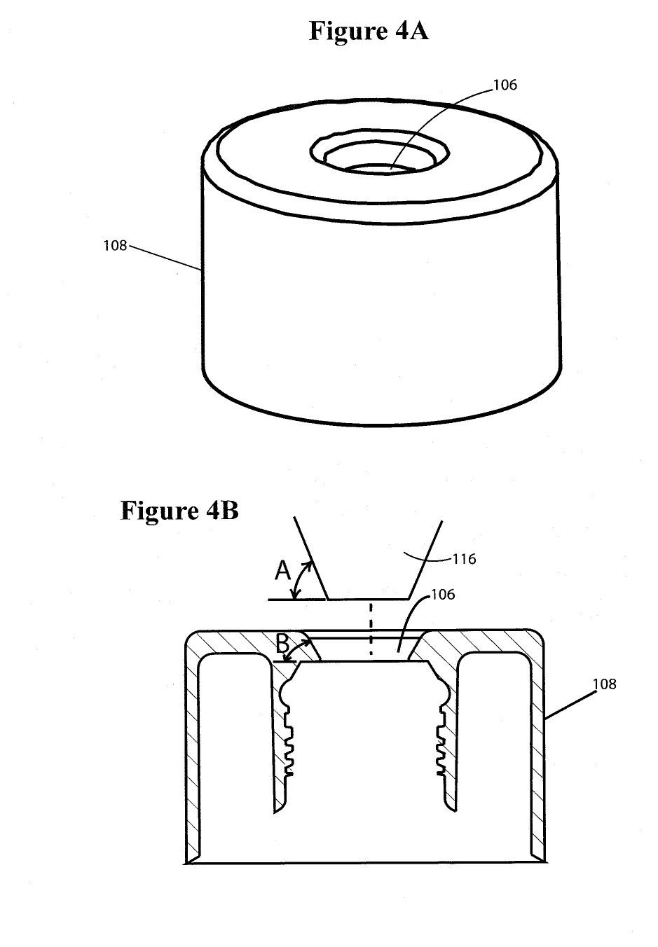

FIG. 1 is an illustrative embodiment of a cocktail shaker and a carbonation device according to aspects of the present disclosures. The cocktail shaker system 100 includes a cocktail shaker container 102 and a gas delivery device 104. In one illustrative embodiment, the cocktail shaker 102 includes a gas port 106 in a small cap coupled with a small opening (not shown in FIG. 1), and a large cap 110 coupled to a large opening 216. The large cap 110 is coupled to a body 112 of the cocktail shaker 102. The gas port 106 is generally used to introduce the CO2 into the cocktail shaker 102 through a one-way self-sealing valve, more fully described below with respect to FIG. 2. The gas port 106 has a conical section for coupling to the conical nozzle 116 of the gas delivery device 104. A bottom stand 114, usually made of a pliable but firm material such as rubber, is attached to the bottom of the body 112 for stability, balance, and handling. The operation of coupling the conical nozzle 116 and the gas port 106 is described more fully below with respect to FIGS. 4A and 4B.

The gas delivery device 104 typically includes or is coupled to a source of gas, such as a pressurized gas tank. In one illustrative embodiment, an actuation button or handle 118 is used to start and stop the flow of gas through the conical nozzle 116. In another illustrative embodiment, the flow of gas may be initiated by simply pressing the conical nozzle 116 against the gas port 106. In one illustrative embodiment, the gas delivery device 104 is a self-contained device including a pressurized gas cartridge and pressure regulator in the body 120. Generally, the nozzle 116 has a conical shape for easy, quick, and secure coupling with the gas port 106. In another illustrative embodiment, the gas delivery device 104 may be connected, via a flexible hose or other similar gas delivery means, to a pressure regulator coupled to a bulk pressurized gas tank (not shown in the figure.) In this embodiment, the gas delivery device 104 includes a handle section, coupled to the flexible hose, having an actuation mechanism, such as a button 118, and a nozzle 116. In one illustrative embodiment, the gas delivery device 104 consists of a disposable CO2 cartridge housed within the body 120, a preset adjustable regulator (not shown), a thumb-actuated valve (not shown) that starts and stops gas flow, and a conical rubber nozzle 116 through which gas flows. It is important that the axis of the conical rubber nozzle 116 be at an angle with respect to the axis of the body 120 containing the CO2 cartridge. This is so that the gas delivery device 104 can easily be held in such an orientation while injecting gas that the CO2 cartridge is not inverted. If the CO2 cartridge were inverted while filling, it could allow liquid CO2 to flow thought the regulator and other gas pathways, possibly freezing them up with dry ice and blocking gas flow.

The cocktail shaker 102 may be constructed in many different shapes and sizes without departing from the spirit of the present disclosures. FIG. 2 shows an exploded view 200 of an illustrative embodiment of the cocktail shaker 102. In this embodiment, a cylindrical-shaped cocktail shaker is constructed by assembling the components shown. The components shown include the small cap 108 having the conical gas port 106. A disk 208 may be inserted into the small cap 108 to serve as an interface between the small cap 108 and a self-sealing one-way valve 206. In one illustrative embodiment, the one-way valve 206 is a single piece of food-grade rubber, silicone, urethane, or other synthetic, gas-impermeable, resilient material capable of making a seal. The one-way valve 206 is roughly disk-shaped with a tapered rectangular “snout” protruding downward into the internal space of the cocktail shaker 102. A channel cut through the one-valve 206 forms a passageway through which gas flows during gas injection. A positive differential pressure of the gas across the one-way valve pushes the walls of the snout apart when filling, but as soon as the gas stops flowing, the walls of the snout are pushed back together forming a gas-tight seal. The one-way valve 206, thus, serves as both a one-way valve for filling the cocktail shaker with gas, and as a gasket which creates a gas-tight seal between the small opening and the cap 108.

The disk 208 is typically rigid and made from hard plastics or metal to form a good seal when pressed against the pliable material of the valve 206. The disk 208 typically has an annular ridge on its surface facing the valve 206 to form a gas-tight seal, isolate the valve's opening from its surrounding, and prevent escape of gas during gas injection from the gas port 106. The disk 208 may also have a second annular ridge on the surface facing the underside of the small cap 108 which serves as a low-friction bearing surface, allowing the small cap 108 to slide against the disk while tightening, so that the rotation of the small cap 108 while tightening does not distort the valve and possibly break the integrity of the seal.

The one-way valve 206 may be a duck-bill valve that opens in one direction under gas pressure and self-seals when gas pressure is removed, thus preventing the escape of gas from the cocktail shaker 102. Those skilled in the art will appreciate that other types of one-way valves may be used for this purpose. For example, a spring-loaded ball may be used in a check valve that allows flow of gas in only one direction. A suitable one-way valve may be selected depending on cost, size, and durability requirements. For example, for home use, a one-piece, low-cost rubber duck-bill valve may be used, while for commercial use, a more durable and expensive check valve may be employed.

A strainer 210 may be added to the assembly of the cocktail shaker 102 to prevent solid pieces of material, such as fruit and ice, from falling out when pouring the beverage out of a small opening 212 of the cocktail shaker 102. Surface roughness of the strainer 210 may cause degassing of the liquid as it is being poured through the strainer. For this reason, it is important that the strainer be smooth and have minimal surface area, so as to create as few nucleation sites for forming bubbles as possible. The strainer 210 is simple, smooth, and has minimal surface area, but has a geometry that is still sufficient to keep ice chunks from passing through the small opening. Furthermore, since the strainer 210 is inside the cocktail shaker 102, it is wetted during the shaking process, which further greatly reduces bubble nucleation sites.

The small opening 212 is sealed off when the edge of the valve 206 is pressed against the small opening 212 via the rigid disk 208. The small opening 212 is typically threaded to accept the small cap 108. Twisting the small cap 108 forces the rigid disk 208 onto the valve 206 and the small opening 212, thus sealing it. In one illustrative embodiment, the large cap 110 is integrated with the small opening 212 to form one unit. The large cap 110 may also form a part of the cocktail shaker's internal volume.

The large cap 110 may be threaded at both ends. The end facing the body 112 is threaded to close the large opening 216. In one illustrative embodiment, the fastening mechanism between the large cap 110 and the body 112 is a half-twist large thread for easy and fast thread acquisition and coupling. In another illustrative embodiment, the fastening mechanism is a hook and recess arrangement, such that the large cap 110 is pressed against the body 112 and then twisted a few degrees (not shown in the figure). In this way, hooks built in to the large cap 110 (or body 112) are pressed towards the body 112 to engage recessed receivers built in to the body 112 (or large cap 110) and then twisted so that the hooks are retained in the recesses receivers. Those skilled in the art will appreciate that other fastening mechanisms may be used without departing from the spirit of the disclosures. It is critical for usability that the large cap 110 and the body 112 be capable of being quickly engaged and disengaged. In an illustrative embodiment, this is accomplished with a bayonet-style twist break, in which several pegs on the top half engage several channels on the lower half, said channels being slightly inclined, so that when the pegs are engaged in the channels and the two halves are twisted, the top half is drawn down the lower half until the O-ring 214 is sandwiched between the bottom surface of the large cap 110 and the upper surface of the body 112. In another illustrative embodiment, coarse acme- or buttress-style threads may be used to join the large cap 110 and the body 112, but this arrangement may take more time to screw the two halves together. In another illustrative embodiment, the threads may be formed in an interrupted manner in several annular channels to allow for easy engagement, thus mimicking the functionality of the bayonet-style engagement described above.

In one illustrative embodiment, the volume of the cocktail shaker 102 is divided between an upper volume formed by the large cap 110 and a lower volume formed by the body 112. The large opening 216 is the dividing surface between these lower and the upper volumes. The ratio of the lower and upper volumes is important. The lower volume is designed to contain a predetermined number of units of beverages, for example, three 12-ounce glasses. The upper volume is designed to hold enough gas at a predetermined pressure to carbonate the entire volume of beverage held in the lower volume. The predetermined CO2 gas pressure for sparkling drinks is typically about 60 PSI (pounds per square inch). This pressure level strikes a good balance between carbonation rates for the volume of liquids being carbonated, and economy of CO2 usage, which is especially important when using disposable CO2 cartridges.

The area of the large opening 216 is also important. This area needs to be big enough to easily introduce ice and other solid ingredients like fruit wedges, but small enough to limit the force of gas pressure acting on the large cap 110 and body 112. Generally, the force, due to gas pressure, acting on and pushing apart the large cap 110 and body 112 equals the gas pressure multiplied by the surface area of the large opening 216. So, the larger the area of the large opening 216, the more force is applied to the large cap 110 and body 112. For example, if the radius of the opening is doubled, the force against the fastening mechanism coupling the large cap 110 and body 112 (e.g., threads) quadruples. In general, the opening should be as small as possible while still allowing the easy introduction of ice and use of a muddling stick.

In one illustrative embodiment, a bottom stand or cap 114 is used to provide stability for the cocktail shaker when set on a flat surface, such as a bar counter or a table. The bottom stand 114 may additionally improve handling of a potentially wet and slippery cocktail shaker 102 (for example, due to condensation caused by cold cocktail shaker 102.) The bottom stand 114 may also be slightly weighted to balance the cocktail shaker 102 during shaking, putting less stress on hands and wrist. The bottom stand 114 also forms a non-skid surface for placing the cocktail shaker 102 on tables and provides shock absorption if the cocktail shaker 102 is dropped. In one illustrative embodiment, an annular hole is provided in the middle bottom stand 114, allowing for a light to be shown into the container from the bottom while filling with gas, producing some rather spectacular visual effects.

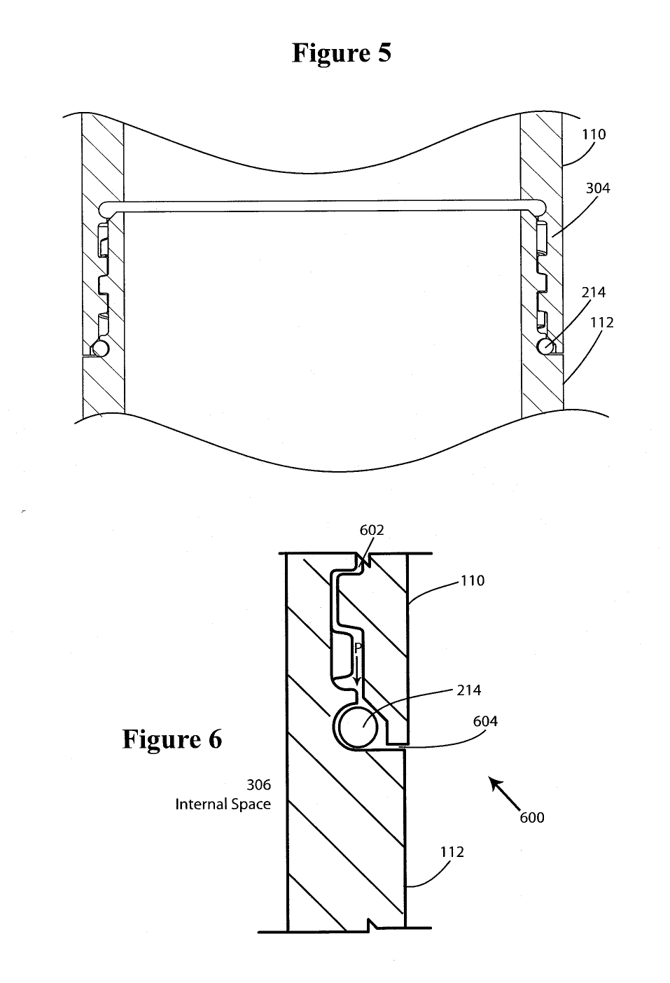

In an illustrative embodiment, an O-ring 214 is employed to seal the large opening 216. As further described below with respect to FIGS. 5 and 6, the O-ring 214 seals the container under the pressure of the gas injected through the gas port 106. Those skilled in the art will appreciate that the components discussed above are illustrative and do not so limit the disclosure. Other arrangements are possible without departing from the spirit of the disclosures. For example, some of the components, such as the disk 208 and the one-way valve 206, may be integrated together to form a one-piece component performing several functions.

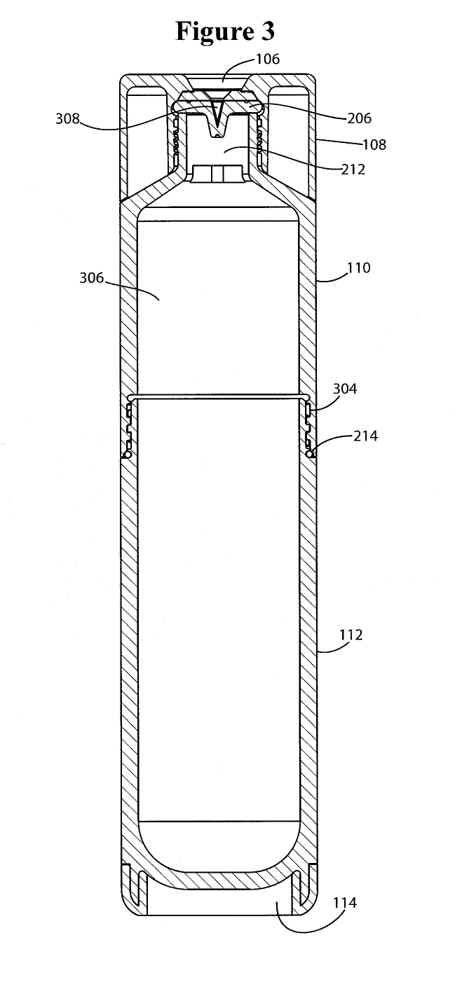

FIG. 3 shows some of the internal details of the cocktail shaker 102. In one illustrative embodiment, the gas port 106 has a conical section for interfacing with the nozzle 116. The duckbill one-way valve 206 includes a triangular section inlet 308 which permits injection of gas from outside but does not allow the gas to escape from an internal space 306. In operation, the inlet 308 of the duckbill valve 206 spreads apart under gas pressure from the nozzle 116 and allows the gas to pass through to the internal space 306. The gas delivery device 104 is generally configured to stop the gas flow at a predetermined pressure, such as 60 PSI. During injection of gas into the cocktail shaker 102, when the predetermined pressure is reached, the gas injection stops and the inlet 308 shuts closed under its own elastic force as well as the internal gas pressure of the cocktail shaker 102, now at the predetermined pressure. No gas can escape from the now sealed inlet 308 or the small opening 212 sealed by the rim of the duckbill valve 206. The only other outlet for gas is the large opening 216, which is also sealed under gas pressure by the O-ring 214.

FIGS. 4A and 4B show details of the conical section of gas port 106. In one illustrative embodiment, the gas port 106 has a conical section to interface with the nozzle 116. The nozzle 116 includes, in one illustrative embodiment, a conical rubber tip with a concentric hole through which gas flows. The nozzle 116 and the gas port 106 form a tight seal at a wide range of angles of engagement between the nozzle 116 and the gas port 106. The engagement between the nozzle 116 and the gas port 106 need not be collinear to form a gas-tight seal because the intersection between a conical nozzle 116 and the top surface of the gas port 106 is an ellipse, which is a planar shape and can operate at a wide range of angles between the nozzle 116 and the gas port 106. This is in contrast with the behavior of a Schraeder valve, found on automobile tires, which requires a co-linear mating of the gas nozzle and the valve to prevent gas from escaping during inflation. Angles A and B, for the nozzle 116 and the gas port 106, respectively, are generally different to accommodate different angles of engagement. Angle B of the gas port 106 is smaller so that the nozzle 116 can be coupled with the gas port 106 at various angles without breaking the coupling seal while injecting gas. Because of the secure coupling between the nozzle 116 and the gas port 106, it is possible to fill the cocktail shaker 102 in an upside down position. In the upside down position, the gas blasts up through the liquid while filling, aiding the absorption process, and creating a spectacular visual effect.

The gas port 106 has a circular shape on its upper surface, as shown in FIG. 4A, which is greater in diameter than the smallest diameter of the conical nozzle 116 (i.e., the tip of the nozzle where gas is discharged into the cocktail shaker), but smaller in diameter than largest diameter of the conical nozzle 116. The precise dimensions are chosen so that the conical nozzle 116, when engaged, couples with the gas port at about midway between the top and the tip of the conical nozzle 116. The conical section of the gas port 106 prevents undue wear of the rubber conical nozzle 116 and provides a better mate between the two parts, as described above.

In operation, a typical usage pattern starts when a user breaks the large cap 110 and the body 112 apart and adds the required ingredients to the lower half of the container. These ingredients may include, but are not limited to, ice, various alcohols and juices, fruit wedges, etc. In one illustrative embodiment, the bottom of the cocktail shaker 102 is rounded both for strength, and to facilitate “muddling” of fruits if this is called for in the particular cocktail recipe. After the drink is mixed, the top half, i.e., the large cap 110, of the cocktail shaker 102 is locked onto the bottom section, the body 112. Only finger-tight force is required, as gas pressure on the O-ring 214 will actually complete the seal between two sealing surfaces (the large cap 110 and the body 112) by pushing the O-ring 214 against the sealing surfaces. Requiring a small manual force for locking up the cocktail shaker 102 such that it is completely gas-tight at high pressures is important for efficient and easy use in repeated applications for making many cocktails in a private or commercial setting. The small cap 108 on top is then tightened to render the entire cocktail shaker 102 gas-tight at high pressures. Next, the gas, for example, CO2, is injected using the gas source 104. The nozzle 116 is pressed against the conical surface of the gas port 106 to inject the gas. The user then activates gas flow by pressing the button 118 or a lever (not shown) in the handle of the gas delivery device 104, and gas flows into the internal space 306 of the cocktail shaker 102. A pressure regulator in the gas delivery device 104 cuts off gas flow at the desired predetermined pressure.

When the desired pressure has been reached, as indicated by the visible cessation of gas flow through the liquid, the user removes the nozzle 116 from the gas port 106. The user then shakes the container for a few seconds, such as approximately five seconds, to cool, dilute, and carbonate the drink. The cocktail shaker 102 is then left to sit for a few more seconds, for example, 10-15 seconds, to let the foam dissipate to minimize the foaming when the small cap 108 is removed. To pour the drink, the cap is slowly removed, and the cocktail is ready to be poured. Slow removal of the small cap 108 is important to prevent agitating the highly carbonated liquid, causing rapid foam production and subsequent gushing. In one illustrative embodiment, the small cap 108 has relatively fine threads of low pitch, enabling the slow removal of the small cap 108 and gradual depressurization of a headspace enclosed by the large cap 110. The built-in strainer 210 keeps ice and/or fruit chunks from being poured into the drink.

FIG. 5 shows a detailed cross section of the coupling between the large cap 110 and the body 112. The large cap 110 couples with and encloses the body 112. In one illustrative embodiment, the O-ring 214 is situated between these two parts so that it is in contact with the outside wall of the body 112. This ensures that the internal gas pressure pushes the O-ring 214 against the sealing surfaces rather than away from the sealing surfaces. In this arrangement, very little torque is required to twist the large cap 110 and seal the cocktail shaker 102. Rather, the pressure of the internal gas forces the O-ring to seal. This arrangement also ensures that the two halves are easy to disengage. Those skilled in the art will appreciate that other arrangements are possible for coupling the large cap 110 and the body 112 without departing from the spirit of the disclosures. For example, the body 112 may enclose the large cap 110 and the O-ring may be retained by the outer surface of the large cap 110.

FIG. 6 shows the O-ring 214 sealing a gap between the large cap 110 and the body 112. When the large cap 110 is twisted shut over the body 112, an internal channel is created between the internal space 306 of the cocktail shaker 102 and outside. The channel leads from an internal entrance 602 to an external exit 604 providing a passageway for the high pressure internal gas to escape through the channel to the outside in absence of any sealing mechanism. The O-ring 214 situated between the external surface of the body 112 and the internal surface of the large cap 110 is in the way of the gas flow in the channel. As the gas flows through the channel, the high pressure of the gas causes the O-ring 214 to get pressed against the sealing surfaces and block the passage of the gas. Thus, the cocktail shaker 102 is self-sealing because of the O-ring 214 so situated between the large cap 110 and the body 112.

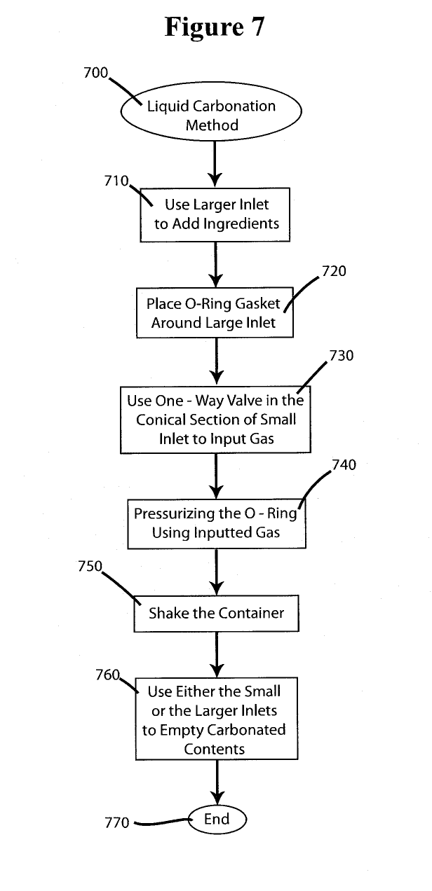

FIG. 7 is a flow diagram showing an illustrative method of making cocktails using the cocktail shaker 102. The method starts at block 700 and proceeds to block 710 where the large opening 216 is used to add liquid as well as solid ingredients such as ice and fruit chunks. The large cap 110 is quickly and easily opened, without application of a large force, in a twist-break fashion to expose the large opening 216. Enough ingredients are added to fill the volume of the body 112 up to the large opening 216. At block 720, the O-ring 214 is ensured to be, or is placed around the outer wall of the body 112 for self-sealing the cocktail shaker 102 when closed. After the ingredients are added to the body section 112, the large cap 110 is coupled with the body 112 and twisted shut. At block 730, the nozzle 116 is coupled with the gas port 106 to inject gas, for example CO2, through the one-way valve 206. Optionally, the gas may be injected with the cocktail shaker 102 turned upside down. This way, the gas blasts through the liquid and creates a visual effect. In an illustrative embodiment, lights may be shown through the bottom stand 114 to enhance the visual effect of gas passing through the liquid cocktail. At block 740, the injection of gas causes the O-ring 214 to seal the channel created by the coupling between the large cap 110 and the body 112, as described above with respect to FIG. 6. At block 750, the user vigorously shakes the cocktail shaker 102 for a few seconds. The shaking, combined with the cooling effect of ice and the gas-tight internal space 306 of the cocktail shaker 102 provides a suitable environment for the CO2 gas to be highly absorbed into the liquid, creating a high-quality sparkling cocktail. At block 760, the user may use either the small opening 212 or the large opening 216 to pour out the sparkling cocktail. When not under gas pressure, the large opening 216 may be exposed by easily twisting the large cap 110 off and decoupling it from the body 112. Under pressure, the threads, or other fastening mechanisms described above, are coupled together under great force preventing the twisting and opening of the large cap 110, while maintaining a tight seal. Accordingly, the user must depressurize the cocktail shaker 102 by opening or loosening the small cap 108 first before opening the large cap 110. Alternatively, the user may use the small opening 212 to pour the sparkling cocktail. In this case, the strainer 210 prevents ice and fruit chunks from pouring out from the cocktail shaker 102.

What is claimed as new and desired to be protected by Letters Patent of the United States is:

1. An apparatus for carbonating beverages, the apparatus comprising:
a container having a first opening and a second opening, wherein the first opening has a different size than the second opening;
a first cap for removably covering the first opening, the cap including a one-way valve with a conical gas port;
a strainer integrated with the first opening; and
a sealing component operable to seal the second opening under internal gas pressure.

2. The apparatus of claim 1, further comprising a conical gas port disposed in the first cap.

3. The apparatus of claim 1, further comprising a second cap for covering the second opening.

4. The apparatus of claim 1, further comprising a bottom stand including light port.

5. The apparatus of claim 1, wherein gas is injected through the conical gas port with the apparatus in an upside-down position.

6. The apparatus of claim 1, wherein the sealing component is an O-ring disposed between a second cap covering the second opening and a body forming the second opening.

7. A system for carbonating beverages, the system comprising:
a CO2 gas source having a conical nozzle with a conical angle;
a container having a first opening and a second opening, wherein the first opening has a different size than the second opening;
a first cap for removably covering the first opening, the first cap including a conical gas port having a conical angle and a one-way valve, wherein the conical angle of the conical gas port is different from the conical angle of the conical nozzle; and
a sealing component operable to seal the second opening under internal gas pressure.

8. The system of claim 7, further comprising a rigid disk for sealing the one-way valve.

9. The system of claim 7, wherein the container further comprises a bottom stand having a light port.

10. The system of claim 7, wherein the second opening is formed by a body section of the container.

11. The system of claim 7, further comprising a second cap for covering the second opening, the second cap enclosing a predetermined proportion of a volume of the container.

12. The system of claim 7, wherein the one-way valve is a duckbill valve.

13. The system of claim 7, further comprising a strainer.

14. The system of claim 7, wherein the second opening is covered by a second cap having a twist-lock closing mechanism.

15. An apparatus for creating carbonated beverages, the apparatus comprising:
a container having a first opening and a second opening formed by a body, the second opening having a larger size than the first opening;
a cap, enclosing a first predetermined volume, removably coupled with the body, the body enclosing a second predetermined volume, wherein the first predetermined volume and the second predetermined volume have a predetermined ratio; and
an O-ring seal disposed between the cap and the body for sealing the second opening.

16. The apparatus of claim 15, further comprising a one-way valve for gas injection integrated with the first opening.

17. The apparatus of claim 15, further comprising a strainer integrated with the first opening.

18. The apparatus of claim 15, wherein the cap is coupled with the body using a twist-lock closing mechanism.

19. The apparatus of claim 15, wherein the O-ring seal seals a gap between the cap and the body under internal gas pressure when the cap is coupled with the body.

20. The apparatus of claim 15, wherein the container is filled with gas in an upside-down position.
